(19) United States
(12) Patent Application Publication
(10) Pub. No.: US 2002/0167174 A1
(43) Pub. Date: Nov. 14, 2002

(54) Portable generator for commucications systems

(76) Inventors: Michael A. Haass, Bellingham, WA (US); Gilford A. McPhillips, Bellingham, WA (US); David L. Stricker, Bellingham, WA (US)

Correspondence Address: SCHACHT LAW OFFICE, INC., 2801 Meridian St., Suite 202, Bellingham, WA, 98225, US

(21) Appl. No.: 10/143,241

(22) Filed: May 9, 2002

Related U.S. Application Data
(60) Provisional application No. 60/290,163, filed on May 9, 2001.

(51) Int. Cl. H02P 9/00

(52) U.S. Cl. 290/1 A

(57) ABSTRACT

A generator system for providing power to communications equipment. The generator comprises an engine, an alternator, a rectifier, and a cable connected between the rectifier and the communications equipment. The engine converts fuel energy into rotation of an output shaft. The alternator is operatively connected to the output shaft to convert the rotation of the output shaft into a raw alternating current power signal. The rectifier generates a direct current power signal based on the raw power signal. The generator preferably comprises a controller for controlling the engine based on the load requirements of the communications equipment. A select switch may be provided to cause the controller to control the rectifier to generate the direct current power signal at first and second predetermined levels. The generator preferably comprises first and second sensors for generating first and second sense signals, where the controller controls the engine at least in part based on at least one of the first and second sense signals. The generator also may preferably comprise a converter operatively connected to the alternator for generating an auxiliary power signal having characteristics different from those of the direct current power signal.

### RELATED APPLICATIONS

This application claims priority of U.S. Provisional Patent Application Serial No. 60/290,163, which was filed on May 9, 2001.

### FIELD OF THE INVENTION

The present invention relates to electrical generators and, more particularly, to portable generators that employ an internal combustion engine as a power source.

### BACKGROUND OF THE INVENTION

Many machines and devices require electrical power to operate.

Often, utility electrical power is not available or is not within acceptable operating parameters. For example, remote locations may not be within the area covered by the utility power grid, or a person may wish not to purchase electrical power from the utility company. In other situations, utility power may be disrupted or not be within certain parameters.

In situations where utility power is not available, it is common to use an electrical generator to supply electrical power, often on a temporary basis but sometimes as a main source of electrical power. A portable electrical generator may be transported to a remote location and operated to supply electrical power at the remote location. If utility power is disrupted or becomes unacceptable for any reason, an electrical generator may be transported to a remote location to provide temporary power until acceptable utility power service is restored.

The present invention relates to electrical generators that generate electrical energy from an internal combustion engine. Internal combustion engines typically burn a fuel such as gasoline, liquefied petroleum gas, diesel oil, and/or natural gas in a controlled manner that results in the rotation of an output shaft. When used with an electrical generator, rotation of the output shaft causes an electrical conductor to move through a magnetic field to induce an electrical signal in the conductor. The induced electrical signal is then processed into an appropriate power signal.

The present invention is particularly suited for use as a portable power supply for use in communications systems such as CATV or telephony systems, and that application will be described herein in detail. It should be understood that the present invention may have broader application to other environments, and the scope of the present invention need not be limited to a particular embodiment designed for communication systems.

### SUMMARY OF THE INVENTION

The present invention is a generator system for providing power to communications equipment. The generator comprises an engine, an alternator, a rectifier, and a cable connected between the rectifier and the communications equipment. The engine converts fuel energy into rotation of an output shaft. The alternator is operatively connected to the output shaft to convert the rotation of the output shaft into a raw alternating current power signal. The rectifier generates a direct current power signal based on the raw power signal.

In one embodiment, the generator preferably comprises a controller for controlling the engine based on the load requirements of the communications equipment. A select switch may be provided to cause the controller to control the rectifier to generate the direct current power signal at first and second predetermined levels.

In another embodiment, the generator preferably comprises first and second sensors for generating first and second sense signals, where the controller controls the engine at least in part based on at least one of the first and second sense signals.

In a third embodiment, the generator also may preferably comprise a converter operatively connected to the alternator for generating an auxiliary power signal having characteristics different from those of the direct current power signal.

The portable generator of the present invention may be embodied in a form that comprises any one, two, or all three of the separate embodiments described above.

### BRIEF DESCRIPTION THE DRAWING

FIG. 1 is a perspective view of an exemplary portable generator of the present invention;

FIG. 2 is a simplified block diagram of an exemplary electrical system of the portable generator depicted in FIG. 1;

FIG. 3 is a somewhat schematic side elevation view depicting a locking system used by the exemplary portable generator of the present invention;

FIG. 4 is a somewhat schematic circuit diagram depicting one exemplary rectifier circuit that may be used by the portable generator of FIGS. 1 and 2;

FIG. 5 is a block diagram depicting one exemplary converter circuit that may be used by the portable generator of FIGS. 1 and 2;

FIG. 6 is a functional block diagram depicting one exemplary controller circuit that may be used by the portable generator of FIGS. 1 and 2; and

FIG. 7 is a functional block diagram of one exemplary environment in which the present invention may be used.

### DETAILED DESCRIPTION OF THE INVENTION

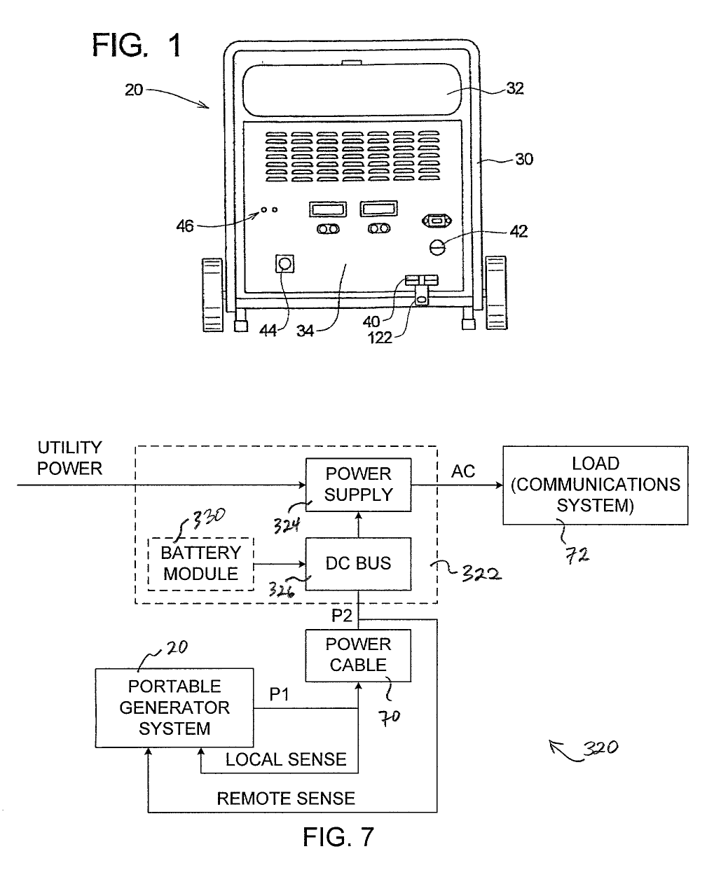

Referring initially to FIG. 1 of the drawing, depicted at 20 therein is a portable generator constructed in accordance with, and embodying, the principles of the present invention. The generator system 20 is designed for use in a communications system such as a telephony system or a cable television (CATV) system.

As shown in FIG. 1, the generator system 20 comprises a rigid frame 30, a fuel tank 32, and a front panel 34. The rigid frame 30 and fuel tank 34 are or may be conventional and will not be described in detail herein. The front panel 34 comprises an output connector 40, a select switch 42, an auxiliary connector 44, and a fault indicator 46.

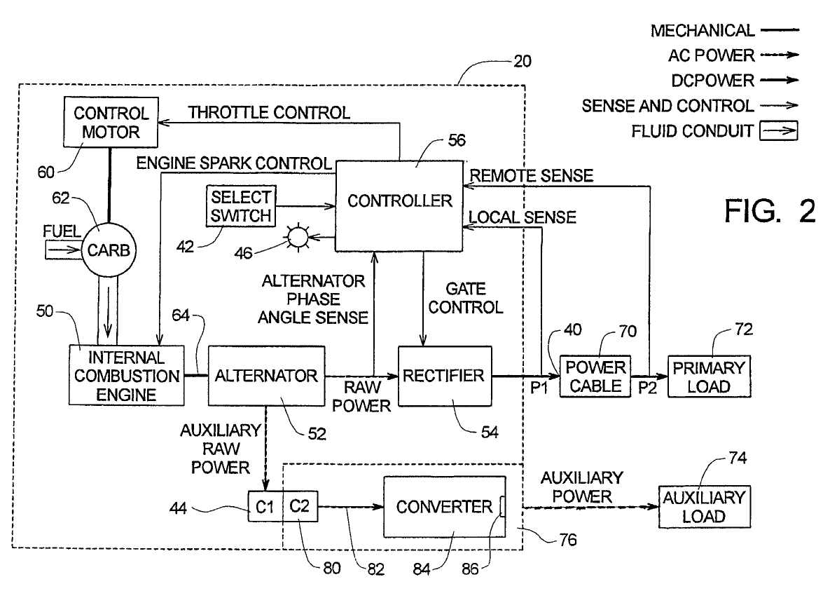

Referring now to FIG. 2, the generator system 20 is depicted therein in further detail. FIG. 2 shows that the generator system 20 further comprises an internal combustion engine 50, an alternator 52, a rectifier 54, a controller 56, and a fuel supply system 58. The fuel supply system 58 comprises a control motor 60 and a carburetor 62.

The internal combustion engine 50 is or may be conventional and is configured to burn a fuel such as gasoline, liquefied petroleum gas, diesel oil, and/or natural gas. In the exemplary generator system 20, the engine 50 is configured to burn gasoline stored in the tank 32. However, the engine 50 may be configured or adapted to consume other fuels, and the fuel source may provide a continuous supply of fuel such as natural gas rather than a finite quantity of fuel stored in a tank. The system 20 may be configured to use a Honda GX 200 6.5 HP engine.

The alternator 52 is in many respects conventional. The exemplary alternator 52 is a permanent magnet, brushless, bearingless alternator manufactured by Coleman Powermate. The alternator 52 is operatively connected to an output shaft 64 of the motor 50 and generates a raw power signal. The exemplary alternator 52 also contains an additional winding that generates an auxiliary raw power signal. The voltage and frequency of the auxiliary raw power signal are non-standard (e.g., other than typical utility voltages and frequencies used in consumer electronics); the purpose of the auxiliary raw power signal will be described in further detail below.

The rectifier 54 is or may be conventional and is designed to generate a DC power signal at one or more predetermined voltages based on the raw power signal generated by the alternator 52. The exemplary rectifier 54 is designed to generate regulated DC power signals at 36 volts and 48 volts.

The exemplary generator system 20 is thus capable of generating the AC auxiliary raw power signal described above or DC power signals at one of two different predetermined levels. The selection between the two DC power levels is made by the select switch 42. The exemplary select switch 42 is a key-operated, three position switch labeled 48V, RESET, and 36V. The system 20 generates 48 and 36 volts DC in the 48V and 36V positions, respectively.

The auxiliary raw power signal is available in the any of the 48V, RESET, or 36V positions. However, the controller 56 controls the control motor 60 and engine 50 based on one or more of the raw power signal or power signals P1 and P2. The level of the auxiliary power signal may thus fluctuate based on the needs of the primary load.

The select switch 42 may be implemented using other switches or combinations of switches providing at least two choices corresponding to the 48V and 36V positions; the select switch may also be implemented in software running on the controller 56; such software will make the appropriate selection in response to an input device such as a keypad, mouse, keyboard, trackball, buttons, or the like.

In certain situations, it may be desirable to regulate the auxiliary power signal; in this case, an auxiliary power sense signal will be generated based on the output of the converter 84. In this case, the controller 56 will control the control motor 60 and engine 62 based on the auxiliary power sense signal. Regulation based on the auxiliary power signal can be automatic, may be a choice implemented by placing the select switch in the RESET position, or may be implemented using other means.

The controller 56 may be implemented using discrete components but preferably comprises a microprocessor having the capability to run software (or firmware) implementing logic and signal processing functions as described herein. The controller 56 receives sense signals corresponding to system variables and generates control signals that control the operation of the various system components. The operation of the exemplary controller 56 will be described throughout the following detailed discussion of the invention.

Referring for a moment back to FIG. 2, it can be seen that the generator system 20 is designed for use as part of a larger system comprising one or more of a power cable 70, a primary load 72, and/or an auxiliary load 74. If the larger system comprises an auxiliary load 74, an auxiliary power supply unit 76 will also be used.

The power cable 70 is connected between the output of the rectifier 54 and the primary load 72. The characteristics of the power cable 70 will generally be determined by environmental characteristics such as the physical distance between the generator system 20 and the power requirements of the primary load 72. The characteristics of the power cable 70 are thus generally unknown at the time the generator system 20 is designed and built. In some situations, because the DC power signal is a high current signal, the length of the power cable 70 can affect the voltage of the DC power signal at the primary load 72. Accordingly, the DC power signal is referred to as P1 on the rectifier side of the power cable 70 and P2 on the primary load side of the power cable 70.

Normally, P2 will be less than P1. For certain cable lengths and characteristics, the difference between P1 and P2 will be negligible. However, greater lengths and characteristics of the power cable 70 can cause P2 to be significantly lower than P1. The significance of the effects of cable characteristics on the power signal P2 will be discussed in further detail below.

The auxiliary power supply unit 76 comprises a connector 80, a cable 82, and an auxiliary converter 84. The connector 80 connects one end of the cable 82 to the auxiliary connector 44 such that the auxiliary raw power signal is passed to the auxiliary converter 84. The auxiliary converter 84 generates an auxiliary power signal at a standard outlet 86 based on the auxiliary raw power signal. The auxiliary power signal is typically an alternating current power signal having the same voltage amplitude and frequency as utility power. The auxiliary load 74 may thus be any conventional electronic device having a standard plug that fits the standard outlet 86.

The 36 or 48 volt DC power signal generated by the system 20 may be used directly with CATV and telephony equipment, respectively, but cannot be used by most conventional consumer electronics. Accordingly, physically separating the auxiliary converter 84 from the generator system 20 renders the generator system 20 useless as a power supply for conventional consumer electronics in the absence of the auxiliary power supply unit 76. The use of an auxiliary power supply unit 76 separate from the generator system 20 substantially eliminates the value of the system to anyone not in the CATV or telephony industries and thus reduces the likelihood that the generator system 20 will be targeted by thieves.

The generator system 20 will often be left in the field unattended. Because the systems 20 are essentially valueless to most people, thieves are less likely to steal the generator systems 20 or destroy equipment and structures associated with the generator systems 20 during attempts to steal the systems 20.

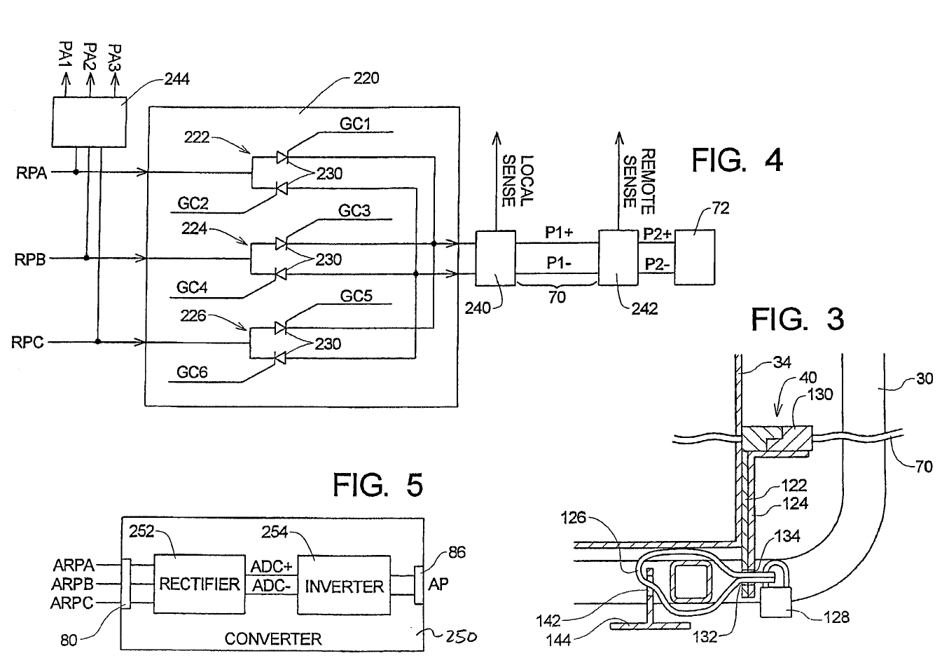

Another security feature of the exemplary generator system 20 is depicted in FIG. 3. FIG. 3 shows a locking system 120 designed to securely lock the power cable 70 to the front panel 34 and the front panel 34 to the frame 30. Optionally, the locking system 120 may also be used to securely lock the entire generator system 20 to a fixed structure.

The exemplary locking system 120 comprises a panel bracket 122 (FIGS. 1 and 3), a connector bracket 124, an elongate lock member 126, and a locking device 128. The panel bracket 122 is welded or otherwise securely attached to the front panel 34. The connector bracket 124 is securely attached to a connector portion 130 of the power cable 70. The power cable connector portion 130 is adapted to mate with the output connector 40. Through holes 132 and 134 are formed in the brackets 122 and 124 such that, when the connector portion 130 mates with the output connector 40, the through holes 132 and 134 are substantially aligned.

The locking system 120 may be used in a number of ways. The lock device 128 may be passed directly through the aligned through holes 132 and 134 to secure the power cable 70 to the front panel 34. Alternatively, the lock member 126 may be passed through the aligned holes 132 and 134 and secured with the lock device 128. Another alternative is to pass the lock member 126 through the through holes 132 and 134 and around a portion of the frame 30 as shown at 140 in FIG. 3. Yet another alternative is to pass the lock member 126 through the through holes 132 and 134, around the frame portion 140, and through a through hole 142 formed in a structural member 144.

The lock member 126 is or may be conventional and may be a chain or hardened wire capable of passing through the various through holes 132,134, and/or 142 described above. The lock device 128 also is or may be conventional and may be a conventional padlock.

Referring now to FIG. 4, depicted at 220 therein is a simplified circuit diagram illustrating the construction of one exemplary rectifier circuit that may be used as the rectifier 54 described above. The rectifier circuit 220 comprises three pairs 222, 224, and 226 of SCR's 230. FIG. 4 also shows that the raw power signal generated by the exemplary alternator 52 is a three-phase signal carried by conductors RPA, RPB, and RPC to the SCR pairs 222, 224, and 226 respectively. The SCR's 230 are controlled by gate control signals GC1, GC2, GC3, GC4, GC5, and GC6 generated by the controller 56. The generation of gate control signals to control the SCR's 230 to obtain the DC power signal P1 at the connector 40 is or may be conventional and will not be described in further detail herein.

FIG. 4 further shows that the local sense and remote sense signals are generated by sensors 240, 242 and that first, second, and/or third alternator phase angle sense signals PA1, PA2, and PA3 are generated by a sensor system 244. Again, the generation of these sense signals may be conventional and will not be described herein in detail. As will be described in further detail below, the controller 56 generates the gate control signals GC1-6 based on one or more of the phase angle signals PA1, PA2, and PA3.

Referring for a moment now back to FIG. 5, depicted therein is an exemplary converter circuit 250 that may be used as the converter 84 described above. The exemplary converter circuit 250 comprises a rectifier circuit 252 and an inverter circuit 254. The rectifier circuit 252 is any circuit capable of generating a DC power signal based on the auxiliary raw power signal. The inverter circuit 254 is any circuit capable of generating the AC auxiliary power signal based on a DC power signal.

In particular, as shown in FIG. 5 the exemplary auxiliary raw power is a three-phase alternating current signal comprising signals ARPA, ARPB, and ARPC carried on three separate conductors. The rectifier circuit 252 generates an auxiliary DC power signal ADC based on the auxiliary raw power signals ARPA, ARPB, and ARPC. The inverter circuit 254 generates the single-phase AC auxiliary power signal AP based on the auxiliary power signal ADC. The auxiliary power signal AP is accessed through the connector 86 as generally described above.

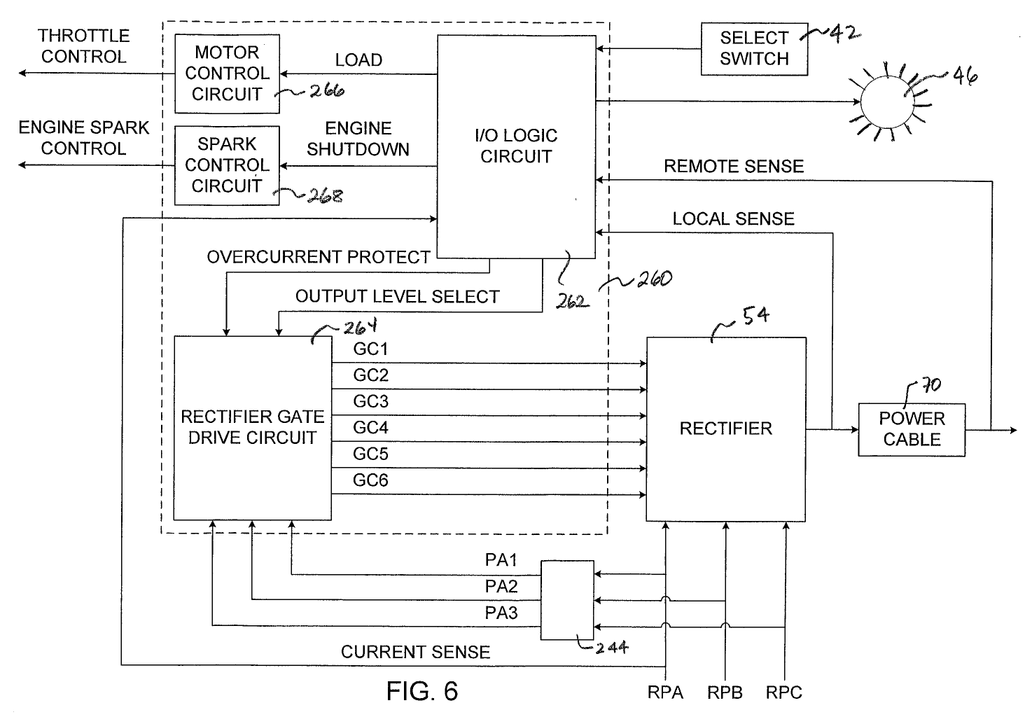

Depicted at 260 in FIG. 6 is one exemplary embodiment of the controller 56 described above. The exemplary controller circuit 260 comprises an I/O-logic circuit 262, a rectifier gate drive circuit 264, an engine control circuit 266, and a spark control circuit 268.

The I/O-logic circuit 262 comprises buffering and scaling circuits to generate a load signal based on one or both of the local sense and remote sense signals. The engine control circuit 266 generates a throttle control signal based on the load signal.

The I/O-logic circuit 262 further comprises logic circuitry that generates an overcurrent protect signal and an engine shutdown signal should the local and/or remote sense signals indicated a fault condition. The overcurrent protect signal directs the rectifier gate drive circuit to open the SCR's 230, and the engine shutdown signal directs the engine control circuit 266 to generate the engine spark control signal to prevent operation of the engine 50. The exemplary I/O-logic circuit 262 monitors a current sense signal indicative of an overcurrent fault condition.

The I/O-logic circuit 262 further comprises buffer circuits that operate the fault indicator 46 when a fault condition is sensed. The fault indicator 46 may be one or more of a lamp, a buzzer, a display, and a link to a central monitoring station.

The I/O-logic circuit 262 further comprises buffer circuits that receive signals from the select switch 42 and generate an output level select signal based on the setting of the switch 42. The output level select signal directs the rectifier gate drive circuit 264 to control the rectifier 54 to generate the DC power signal at the predetermined level (e.g., 36V or 48V) corresponding to the setting of the switch 42.

One of ordinary skill in the art will recognize that the functions represented by the block diagram of FIG. 6 may be implemented in many different ways. For example, these functions can be performed by a microprocessor and associated RAM and ROM memory running software and/or firmware that implements the logic, engine control, and voltage regulation processes described herein. These functions may also be performed by a circuit (discrete or integrated) formed by individual components. Another system for performing these functions may comprise a combination of a microprocessor and associated memory with discrete components.

Referring again to FIG. 2, the operation of the generator system 20 will now be described in further detail.

Typically, the select switch 42 is first placed in the reset mode, and the system 20 is connected to the load 72 using the power cable 70. The generator is then started by starting the engine 50.

The operator then determines the operating characteristics of the load 72 and operates the select switch 42 based on these characteristics. In the exemplary system 20, the operator determines whether the primary load operates on 36 or 48 volts DC. The operator then operates the select switch 42 into the position corresponding to the desired 36V or 48V setting and connects the power cable 70 to the output connector 40.

Once the select switch 72 is set and the appropriate cable 70 is connected to the appropriate connector, the engine 50 is started using either a pull starter or an electric starter. The output shaft 64 of the engine 50 is connected to the alternator 52 such that the alternator 52 generates the raw power signal.

The controller 56 monitors one or more of an alternator sense signal indicative of the raw power signal, a local sense signal indicative of the power signal P1, and a remote sense signal indicative of the power signal P2.

Based on one or both of the local and remote sense signals, the controller 56 generates a throttle control signal that operates the control motor 60. The control motor 60 is mechanically connected to the carburetor 62 such that operation of the control motor 60 increases or decreases the flow of fuel to the engine 50. Generally, as the load increases, the controller 56 increases the fuel to the engine 50 to increase the power generated by the engine 50 and thereby compensate for the increased load.

The use of the remote sense signal is of particular importance because this signal accurately represents the voltage of the power signal P2 at the primary load 72. Thus, the controller 56 will automatically compensate for losses in the power cable 70 by increasing the flow of fuel to the engine 50.

The controller 56 further generates the gate control signals based on the alternator phase angle sense signal. The gate control signals are timed to open and close the SCR's 230 as necessary to obtain a DC signal from the raw power signal generated by the alternator 52.

The controller 56 also may be configured to generate the rectifier control signals to operate the rectifier 54 in an additional mode such as an overcurrent protection mode. For example, should a short circuit occur at the load, one of the sense signals will indicate an unacceptable increase in current, and the controller 56 may place the rectifier 54 in a protection mode in which internal solid-state switches 230 are opened.

The controller 56 may further be configured to generate an engine control signal. The engine control signal may, for example, control the engine 50 to shut down in either a low fuel or overheat situation.

If the operator needs to operate equipment, such as computers, power tools, lights, or the like, that is adapted to operate on standard utility power, the operator may connect the connector 80 of the auxiliary power supply unit 76 to the connector 44. The auxiliary power supply unit 76 is typically housed in a separate physical enclosure from the components 50, 52, 54, and 56 of the portable generator 20. For example, the auxiliary power supply unit 76 may be mounted on a vehicle or in a box with handles that may be arranged next to the portable generator 20. When auxiliary power is needed, the auxiliary power supply unit 76 is connected to the connector 44.

When no auxiliary power is needed or the portable generator 20 is left unattended, the auxiliary power supply unit 76 is disconnected from the connector 44 and physically removed. The portable generator 20 may thus be left unattended to generate the power signal for the primary load, but because in this configuration cannot generate a utility standard AC power signal, is not a tempting target for thieves.

Referring now to FIG. 7, depicted at 320 therein is a communications system adapted to use of the portable generator system 20 of the present invention. FIG. 7 depicts, in addition to the portable generator system 20, power cable 70, and primary load 72, an uninterruptible power supply 322.

The uninterruptible power supply 322 typically comprises a power supply 324 that generates an AC signal either based on utility power or based on a DC voltage present on a DC bus 326. Typically, a battery module 330 may also be connected to the DC bus 326. The uninterruptible power supply 322 operates in either a line mode or standby mode. In standby mode, the power supply 322 provides short-term standby power from the battery module 330 in the event of a failure of utility power. In the line mode, the power supply 322 typically charges the batteries in the battery module 330. Uninterruptible power supplies such as the power supply 322 are well-known in the art, and the uninterruptible power supply 322 will not be described herein beyond the extent necessary for a complete understanding of the present invention.

In the system 320, the power cable 70 is connected to the DC bus 326 such that the voltage on the DC bus 326 is equal to at least the voltage P2 described above. The remote sense signal thus allows the portable generator system 20 to regulate its output based on the voltage at the DC bus 326 of the uninterruptible power supply 322.

In addition, the I/O logic circuit 262 of the controller 56 determines if the remote sense signal indicates that the voltage P2 is above a predetermined threshold corresponding to the selected voltage level. If the voltage P2 is above the appropriate predetermined threshold, the system 20 determines that utility power is present. If it is determined that utility power is present, the load signal controls the motor control circuit 266 to generate a throttle control signal that throttles back the engine 50, thereby reducing power output of the system 20 to a minimum.

Regulating the generator system 20 based on the voltage of the DC bus allows the power produced by the portable generator system 20 to be automatically reduced when utility power is restored. The power supplied to the load 72 is thus automatically transferred from the portable generator system 20 to utility power upon restoration of utility power. This conserves fuel consumed by the engine 50 and reduces noise created by the generator system 20. The system 320 thus does not require a transfer switch or an operator to operate the transfer switch to transfer the power source from the generator system 20 to utility power upon restoration of utility power.

From the foregoing, it should be clear that the present invention can be implemented in a number of different embodiments. The scope of the present invention should thus include embodiments of the invention other than those disclosed herein.

We claim:

1. A generator system for providing power to communications equipment, comprising:
an engine for converting fuel energy into rotation of an output shaft;
an alternator operatively connected to the output shaft for converting the rotation of the output shaft into a raw alternating current power signal;
a rectifier for generating a direct current power signal based on the raw power signal;
a cable operatively connected between the rectifier and the communications equipment to supply the direct current power signal to the communications equipment;
a controller for controlling the engine based on the load requirements of the communications equipment; and
a select switch operatively connected to the controller, where the select switch operates in at least first and second positions; whereby
when the select switch is in the first position, the controller controls the rectifier to generate the direct current power signal at a first predetermined level, and
when the select switch is in the second position, the controller controls the rectifier to generate the direct current power signal at a second predetermined level.

2. A generator system as recited in claim 1, further comprising a sensor for generating a sense signal indicative of a voltage level of the direct current power signal, where the controller controls the engine at least in part based on the sense signal.

3. A generator system as recited in claim 1, further comprising first and second sensors for generating a first and second sense signal indicative of a voltage level of the direct current power signal at both ends of the cable, where the controller controls the engine at least in part based on at least one of the first and second sense signals.

4. A generator system as recited in claim 1, further comprising a sensor for generating a sense signal indicative of a phase characteristic of the raw power signal, where the controller further controls the rectifier at least in part based on the sense signal.

5. A generator system as recited in claim 1, further comprising:
first and second sensors for generating a first and second sense signal indicative of a voltage level of the direct current power signal at both ends of the cable; and
a third sensor for generating a third sense signal indicative of a characteristic of the raw power signal; wherein
the controller controls the engine at least in part based on at least one of the first and second sense signals; and
the controller controls the rectifier at least in part based on the third sense signal.

6. A generator system as recited in claim 1, further comprising a converter operatively connected to the alternator for generating an auxiliary power signal having characteristics different from those of the direct current power signal.

7. A generator system as recited in claim 6, in which the auxiliary power signal is an alternating current power signal adapted to power an auxiliary load.

8. A generator system as recited in claim 6, further comprising a connector assembly for detachably attaching the converter to the alternator.

9. A generator system as recited in claim 6, in which the converter comprises:
a rectifier for generating a raw auxiliary direct current power signal based on an auxiliary raw alternating current power signal generated by the alternator; and
an inverter for generating the auxiliary power signal based on the raw auxiliary direct current power signal.

10. A generator system for providing power to communications equipment, comprising:
an engine for converting fuel energy into rotation of an output shaft;
an alternator operatively connected to the output shaft for converting the rotation of the output shaft into a raw alternating current power signal;
a rectifier for generating a direct current power signal based on the raw power signal;
a cable operatively connected between the rectifier and the communications equipment to supply the direct current power signal to the communications equipment;
a controller for controlling the engine based on the load requirements of the communications equipment; and
first and second sensors for generating a first and second sense signal indicative of a voltage level of the direct current power signal at both ends of the cable; wherein the controller controls the engine at least in part based on at least one of the first and second sense signals.

11. A generator system as recited in claim 1, further comprising a third sensor for generating a sense signal indicative of a phase characteristic of the raw power signal, where the controller further controls the rectifier at least in part based on the third sense signal.

12. A generator system as recited in claim 1, further comprising a converter operatively connected to the alternator for generating an auxiliary power signal having characteristics different from those of the direct current power signal.

13. A generator system as recited in claim 12, in which the auxiliary power signal is an alternating current power signal adapted to power an auxiliary load.

14. A generator system as recited in claim 12, further comprising a connector assembly for detachably attaching the converter to the alternator.

15. A generator system as recited in claim 12, in which the converter comprises:
a rectifier for generating a raw auxiliary direct current power signal based on an auxiliary raw alternating current power signal generated by the alternator; and
an inverter for generating the auxiliary power signal based on the raw auxiliary direct current power signal.

16. A generator system for providing power to communications equipment, comprising:
an engine for converting fuel energy into rotation of an output shaft;
an alternator operatively connected to the output shaft for converting the rotation of the output shaft into a raw alternating current power signal;
a rectifier for generating a direct current power signal based on the raw power signal;
a cable operatively connected between the rectifier and the communications equipment to supply the direct current power signal to the communications equipment; and
a converter operatively connected to the alternator for generating an auxiliary power signal having characteristics different from those of the direct current power signal.

17. A generator system as recited in claim 16, in which the auxiliary power signal is an alternating current power signal adapted to power an auxiliary load.

18. A generator system as recited in claim 16, further comprising a connector assembly for detachably attaching the converter to the alternator.

19. A generator system as recited in claim 16, in which the converter comprises:
a rectifier for generating a raw auxiliary direct current power signal based on an auxiliary raw alternating current power signal generated by the alternator; and
an inverter for generating the auxiliary power signal based on the raw auxiliary direct current power signal.

20. A method of providing power to communications equipment, comprising:
providing an engine for converting fuel energy into rotation of an output shaft;
operatively connecting an alternator to the output shaft of the engine for converting the rotation of the output shaft into a raw alternating current power signal;
operatively connecting a rectifier to the alternator to generate a direct current power signal based on the raw power signal;
operatively connecting a cable between the rectifier and the communications equipment to supply the direct current power signal to the communications equipment;
detachably connecting a converter to the alternator, where the converter generates an auxiliary power signal having characteristics different from those of the direct current power signal.
